(19) United States
(12) Patent Application Publication
(10) Pub. No.: US 2025/0256562 A1
(43) Pub. Date: Aug. 14, 2025

(54) DRIVE SYSTEM FOR A FORAGE HARVESTER

(71) Applicant: DEERE & COMPANY, MOLINE, IL (US)

(72) Inventors: ANDRE KLEIN, KAISERSLAUTERN (DE); STEFAN BOHRER, ST. WENDEL (DE); MICHAEL DANNER, PIRMASENS (DE); DENNIS KREMER, FRANKENSTEIN (DE); GEORG A. KORMANN, ZWEIBRUECKEN (DE)

(21) Appl. No.: 18/974,967

(22) Filed: Dec. 10, 2024

(30) Foreign Application Priority Data
Feb. 9, 2024 (EP) 24156895.5

(51) Int. Cl. B60K 11/02; B60K 6/40

(52) U.S. Cl. CPC B60K 11/02; B60K 6/40; B60Y 2200/222

(57) ABSTRACT

A drive system for a self-propelled agricultural machine includes a power store, e.g., a battery, a DC-DC converter connecting the power store to a DC bus, and an electric motor connected to the DC bus via an inverter. A first cooling circuit circulates a cooling liquid for dissipating heat from the power store. A second cooling circuit circulates a refrigerant for dissipating heat from the cooling liquid of the first cooling circuit. A third cooling circuit dissipates heat from the refrigerant of the second cooling circuit, the DC-DC converter, and the inverter.

### CROSS-REFERENCE TO RELATED APPLICATIONS

This application claims the benefit of European Patent Application No. EP24156895.5, filed on Feb. 9, 2024, the disclosure of which is hereby incorporated by reference.

### TECHNICAL FIELD

The disclosure generally relates to a drive system for a self-propelled agricultural machine, such as but not limited to a forage harvester.

### BACKGROUND

Self-propelled agricultural machines are to an increasing extent equipped with electric motors, the energy supply to which is wholly or partly provided by power stores (e.g., batteries). Such machines can be designed as agricultural tractors or as self-propelled harvesting machines. The electric drive train may have a higher efficiency than a hydraulic drive train. For example, a generator driven by a main drive train is able to feed a battery which, during load peaks, is used to supply the generator, then serving as a motor, with power (EP 1 563 724 A1), or it is possible for a battery to assist or solely supply an electric-motor drive of a driven element of a harvesting machine as necessary, in addition to a motor-driven generator (EP 2 253 196 A1).

In order to store electrical energy in sufficiently large quantities, correspondingly large power stores are needed. Analogously, the motors and generators have to be configured to be sufficiently large. The result of this is that air cooling is no longer sufficient to cool the power store and the motors and generators. Instead, forcible cooling systems are needed in order to provide the cooling of these relatively large components. Electric motors and generators can generally be cooled by oil, while electronic components, such as inverters and DC-DC converters, are cooled by water, to which an antifreeze is usually added.

There remains the problem of cooling the power store. To this end, liquid-cooled arrangements have been described, see WO 2017/067923 A1. However, the working temperatures of conventional power stores, which are generally intended to lie below 40° C., are more likely not to be reached in conventional cooling systems when implemented in agricultural machines.

### SUMMARY

A drive system for a self-propelled agricultural machine is provided. The drive system includes a power store, a DC-DC converter connecting the power store to a DC bus. An electric motor is connected to the DC bus via an inverter. A first cooling circuit is provided for dissipating heat from the power store. A cooling liquid circulates through the first cooling circuit. A second cooling circuit is provided for dissipating heat from the cooling liquid of the first cooling circuit. A refrigerant circulates through the second cooling circuit. A third cooling circuit is provided for dissipating heat from the refrigerant of the second cooling circuit, the DC-DC converter, and the inverter.

In other words, it is proposed to cool the DC-DC converter and the inverter by means of a third cooling circuit, which also cools a second cooling circuit which in turn cools a first cooling circuit of the power store. This three-stage cooling of the first cooling circuit has the advantage that a dissipation of heat from the power store is possible with little additional outlay, namely for the first and second cooling circuit. By means of the second cooling circuit, with a usable efficiency, a sufficiently high temperature gradient between the third and first cooling circuit can be achieved which, firstly, ensures usable temperatures for the power store and, secondly, permits the use for agricultural machines of conventional cooling circuits for electronic components.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic side view of a self-propelled forage harvester.

FIG. 2 is a schematic top view of a drive system of the forage harvester.

FIG. 3 is a schematic illustration of a cooling of electric motors and motor/generators for the drive of feed rollers of a harvesting attachment of the forage harvester.

FIG. 4 is a schematic illustration of the cooling of a battery.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

The terms “forward”, “rearward”, “left”, and “right”, when used in connection with a moveable implement and/or components thereof are usually determined with reference to the direction of travel during operation, but should not be construed as limiting. The terms “longitudinal” and “transverse” are usually determined with reference to the fore-and-aft direction of the implement relative to the direction of travel during operation, and should also not be construed as limiting.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

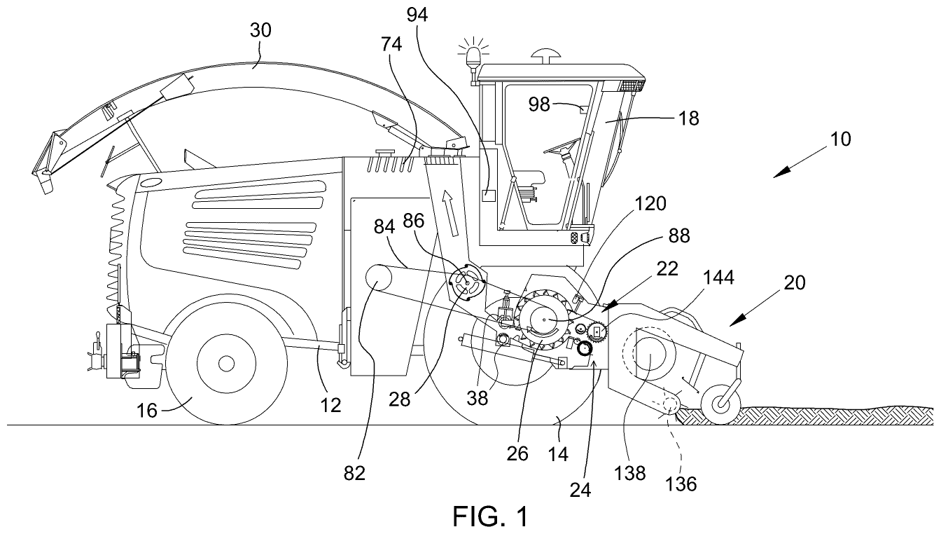

Referring to the Figures, wherein like numerals indicate like parts throughout the several views, a self-propelled forage harvester is generally indicated at 10 in FIG. 1. Referring to FIG. 1, the forage harvester 10 is built on a framework 12 which is supported by driven front wheels 14 and steerable rear wheels 16. The forage harvester 10 is operated from a driver's cab 18, from which a harvesting attachment 20 in the form of a windrow picker is visible. Crop, for example grass or the like, picked up from the ground by means of the harvesting attachment 20, is fed via a feed conveyor having feed rollers 22, which are arranged within a feed housing 24 on the front side of the forage harvester 10, to a chopper drum 26, which is arranged below the driver's cab 18, chops it into small pieces and discharges it to a post-processing device having two grain processor rolls 38 (which can be moved when harvesting grass or moved into a position at a distance) and a conveying device 28 following downstream. The material leaves the forage harvester 10 to a transport vehicle traveling alongside, via a discharge elbow 30 that is rotatable by actuators about an approximately vertical axis, is adjustable in inclination and has a discharge flap that is adjustable using actuators. In the following text, direction indications, such as sideways, downwards and upwards, relate to the forward movement direction V of the forage harvester 10, which runs to the right in FIG. 1.

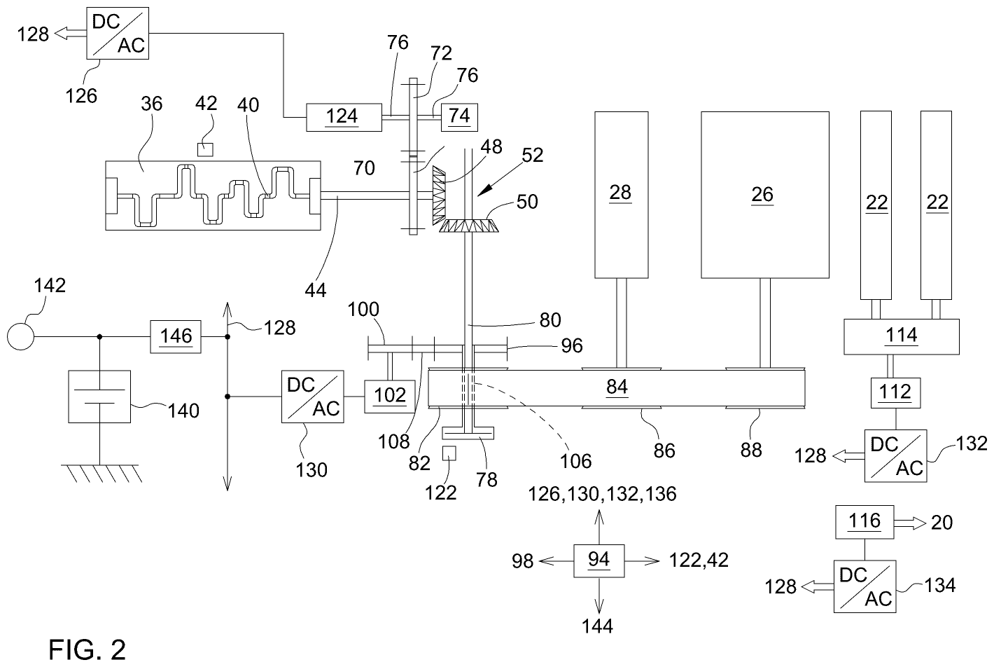

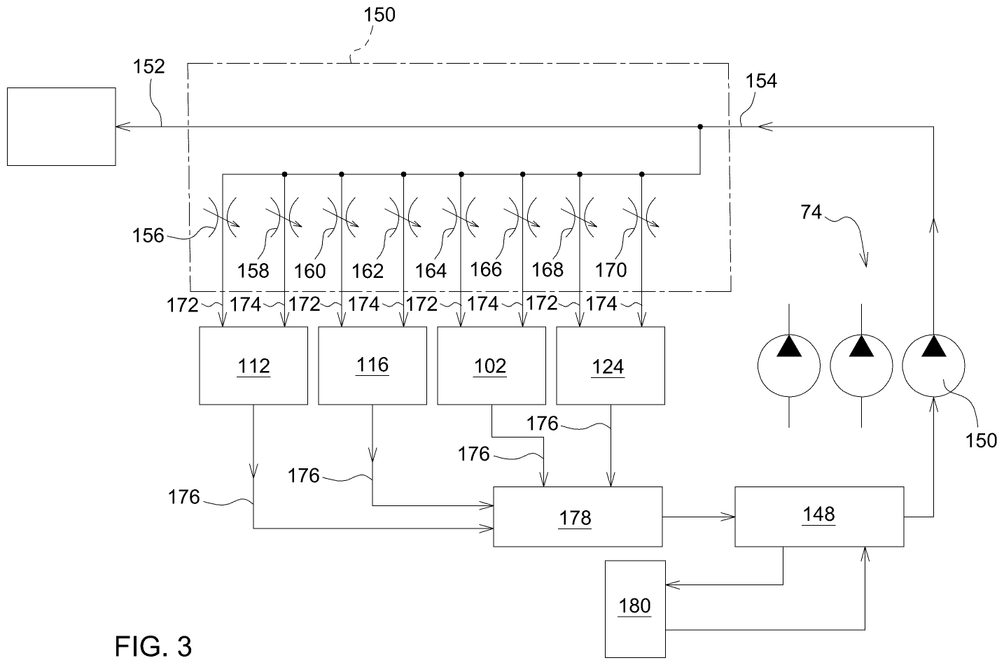

FIG. 2 shows a top view of the drive arrangement of the forage harvester 10. In the rear region of the forage harvester 10 there is an internal combustion engine 36, in particular in the form of a diesel engine. The crankshaft 40 of the internal combustion engine 36 extends in the forward direction of the forage harvester 10. During operation, the crankshaft 40 of the internal combustion engine 36 drives a longitudinal shaft 44, which is connected to the first bevel gear 48 of a bevel drive mechanism 52. The longitudinal shaft 44 also drives, via gear wheels 70, 72 and a second longitudinal shaft 76, a pumping unit 74, which comprises a hydraulic pump for driving hydraulic motors for the forward drive of the harvesting machine, a steering pump, a pump 148 (see also FIG. 3) for supplying the actuators for adjusting the discharge elbow, and a hydraulic pump for the oil supply of the control device of the hydrostatic drive for the forward drive of the harvesting machine 10. It would also be conceivable, via one of the gearwheels 70, 72 or a gearwheel (not shown) arranged between them, to drive further permanently driven elements, such as an electric generator for supplying the on-board power supply of the forage harvester 10, and/or a blower drive for the supply of cooling air for the internal combustion engine 36. The longitudinal shaft 76 additionally is in drive connection to a first motor/generator 124. This can be a conventional three-phase motor with internal permanent magnets. The first motor/generator 124 is electrically connected to a first inverter 126 which, in turn, is connected to a DC bus 128.

The second bevel gear 50 of the bevel drive mechanism 52 is connected to a transverse shaft 80, which extends through a hollow shaft 106 connected to the belt pulley 82 to the side of the belt pulley 82 that faces away from the bevel drive mechanism 52 and, there, is connected to a clutch 78. On the output side, the clutch 78 is connected to the hollow shaft 106, which additionally drives a second motor/generator 102 on the side of the belt pulley 82 that faces the bevel drive mechanism 52 via gearwheels 96, 108 and 100. The clutch 78 enables the drive belt 84 and, with the latter, the chopper drum 26 and the conveying device 28 to be switched on and off. The clutch is disengaged and separated by means of an actuator 122. The second motor/generator 102 is designed as a three-phase generator, analogous to the first motor/generator 124, and is connected to a second inverter 130. The inverter 130 is in turn connected to the DC bus 128.

Furthermore, the DC bus 128 is connected to further inverters 132, 134, of which the inverter 134 is connected to a first electric motor 112, which drives the feed rollers 22 of the feed conveyor via a gear mechanism 114, and the inverter 136 is connected to a second electric motor 116 (arranged on board the forage harvester 10 or on the harvesting attachment 20), which drives some, several or all the driven elements of the harvesting attachment 20. In the case of the windrow picker shown in FIG. 1 as a harvesting attachment 20, the electric motor 116 can, for example, drive the tined roller 134, while the transverse screw conveyor 138 can be coupled in terms of drive to the feed rolls 22 of the feed conveyor or is driven by a further electric motor (not shown).

An electronic control device 94 has a signal-transmitting connection to an operator interface 98, the inverters 126, 130, 132, 134 and an actuator 122 of the clutch and an engine control device 42 of the internal combustion engine 36. The DC bus 128 is connected via a DC-DC converter 146, which can be isolated at the input or output side from the DC bus 128 by a relay, to a rechargeable power store 140 (also designated as a battery or accumulator), which additionally can be connected to an external charging station by means of a charging device 142 and a charging socket.

The function of the control device 94 and of the inverters 126, 130, 132, 134 is such that the control device 94 instructs the bidirectional inverters 126 and 130 to operate the first and second motor/generator 124, 102 as an electric motor or generator, and defines the respective torque and/or the rotational speed on the shaft of the motor/generator 124, 102 and the phase angle of the power drawn or output. In an analogous way, the control device 94 commands the likewise bidirectional inverters 132, 134 to operate the electric motors 112, 116 as an electric motor or generator and defines the respective torque and/or the rotational speed on the shaft of the electric motor 112, 116 and the phase angle of the power drawn or output. In other words, the motors/generators 124, 102 can be switched as generator by the control device 94 in order to charge the power store 140 and to supply the electric motors 112, 116 or to brake the chopper drum 26, or they can be switched as motor in order to drive the chopper drum 26 (for grinding) or to accelerate (when starting up) or to use the internal combustion engine 36 as a brake in order to brake the chopper drum 26. In an analogous way, depending on the instructions from the control device 94, the electric motors 112, 116 can drive the feed rollers 22 and the drivable elements of the harvesting attachment 20 in electric-motor operation and brake same in generator operation. The power flows each run via the DC bus 128.

The drive arrangement illustrated in FIGS. 1 and 2 is accordingly configured to operate at least in the following operating modes under control by the control device 94:
(a) Running up the rotational speed of the chopper drum 26. In order to begin a harvesting operation, first of all the internal combustion engine 36 must be started, which can be initiated by an operator at their workplace in the cab 18 by means of an ignition key or in another way (e.g. via the operator interface 98). The clutch 78 is initially still disengaged, i.e. the chopper drum 26 is at a standstill. The operator can initiate the harvesting operation via the operator interface 98. In order to protect the clutch 78, the control device 94 causes the inverters 126 to operate the first motor/generator 124 as a generator in order to supply the DC bus 128 with electrical power. At the same time, the control device 94 commands the inverter 130 to operate the second motor/generator 102 as an electric motor, so that it accelerates the chopper drum 26. When approximately the same rotational speeds are present on the input and output of the clutch 78 (the control device 94 is connected to appropriate sensors for rotational speed detection in the first section of the drive train of the chopper drum 26, located upstream of the clutch 78, and in the second section of the drive train of the chopper drum 26, located downstream of the clutch 78, or can derive these rotational speeds from signals which are provided by the motor/generators 124, 102 directly or by the inverters 126, 130 by using the currents flowing through the motor/generator 124, 102), the clutch 78 is engaged and the second motor/generator 102 can be commanded to stop accelerating the second section of the drive train of the chopper drum 26. By means of this procedure, the clutch 78 is relatively lightly loaded and has a longer lifetime than if it were to be engaged when the chopper drum 26 was at a standstill.
(b) Harvesting operation. In normal harvesting operation, the internal combustion engine 36 drives the chopper drum 26 and the conveying device 28 via both sections of the drive train which are connected by the clutch 78. The first motor/generator 124 is used as a generator and supplies electrical energy to the DC bus 128, which in turn is used to supply the electric motors 112, 116 which drive the feed rollers 22 and drivable elements of the harvesting attachment 20. The electric motors 112, 116 are activated in response to a corresponding operator entry by means of the operator interface 98. The second motor/generator 102 can likewise be operated as a generator in harvesting operation and supply the DC bus 128, or it runs freely without any power discharge or consumption. Furthermore, depending on demand, in this regard see the explanations further below, the power store 140 can supply additional energy, be it for the electric motors 112, 116 or in special cases with high loading of the chopper drum 26 and/or the conveying device 28, for the first and/or second motor/generator 124, 102. It is advisable to use the first motor/generator 124 preferably as compared with the second motor/generator 102 for converting the mechanical energy provided by the internal combustion engine 36 into electrical energy, since here the clutch 78 is not loaded, while the second motor/generator 102 is used for operating conditions under which the chopper drum 26 and/or the conveying device 28 have to have mechanical energy applied.

The rotational speed of the electric motor 112, together with the rotational speed of the chopper drum 26, determines the cutting length of the crop. This can be predefined by the operator by means of the operator interface 98 or sensors detect crop properties and define the cutting length and thus the rotational speed of the electric motor 112 which is controlled by the control device 94 and the inverter 132. The rotational speed of the electric motor 116 can be fixedly predefined or depend on the cutting length and/or the forward drive speed of the forage harvester 10, cf. EP 1 609 351 A1.
(c) After the harvesting operation or in the case of interruptions, it is expedient to stop the chopper drum 26, firstly to avoid the risk of accidents, secondly to reduce noise. For this purpose, in response to an appropriate entry of the operator into the operator interface 98 or otherwise sensor-based detection of a non-harvesting situation, e.g. when the operator leaves their seat, after the clutch 78 has been disengaged, the second motor/generator 102 is operated as a generator and converts the rotational energy of the chopper drum 26 and of the conveying device 28 into electrical energy, which is supplied to the power store 104 via the DC bus 128 and, in particular, if the latter is sufficiently charged, is supplied to the first motor/generator 124, which is operated as a motor and drives the internal combustion engine 36 actively, so that as a result of this compression action of the cylinders and pistons and friction, engine braking is carried out in order to convert the rotational energy of the chopper drum 26 into heat.
(d) Furthermore, the second motor/generator 102 can be used with the clutch 78 disengaged to drive the chopper drum 26 for grinding with a rotational speed and/or direction of rotation that is changed relative to the harvesting operation. The second motor/generator 102 is then operated as a motor and, if the internal combustion engine 36 is at a standstill, is supplied from the power store or, if the internal combustion engine 36 is running, has electrical power applied to it from the first motor/generator 124. In this regard, reference is made to DE 10 2018 211 863 A1, the disclosure of which is included by reference in full in the present documents.
(e) The forage harvester 10 is further equipped with a foreign body detector 144, which can be designed as a metal detector and/or as a stone detector for the detection of impinging stones and can be installed in the front, upper feed roller 22. When the foreign body detector 144 responds, the control device 94 connected thereto receives a corresponding signal and causes the electric motor 112 to stop. The latter then operates as a generator and the power produced is transmitted via the DC bus 128 to the first motor/generator 124, which converts it by means of the internal combustion engine 36 into heat, analogous to operating mode (c). The engine 116 is also stopped in the manner described.
(f) Hitherto, substantially a so-called hybrid electrical operation has been described, in which in harvesting operation the internal combustion engine 36 drives the motor/generator 124, 102, which in turn supplies the electric motors 112 and 116 with power. Here, the power store 140 is in principle not needed and could also be omitted. By comparison, however, the power store 140 has the advantage that at least a temporary increase in the total drive output of the forage harvester 10 is possible. Therefore, so-called battery operation of the forage harvester 10 is in particular also provided.

For the battery operation, firstly the hybrid electric operation is switched on. The power store 140 can be added via an entry on the operator interface 98. For this purpose, the voltage state of the power store 140 is read by the control device 94. A voltage equal to the current voltage of the power store 140 is predefined to the inverter 126 of the first motor/generator 124 in order to achieve the state in which a minimum current flows to the DC bus 128 at the instant at which the power store 140 is connected. Once this state has been reached, the relay connected to the DC-DC converter 146 of the power store 140 is switched on. The feed rollers 22 and the elements of the harvesting attachment 20 driven by the electric motor 116 can then be fed directly and exclusively (or at least partly, depending on the respective power demand) from the power store 140. This power, previously applied by the internal combustion engine 36, is then free there and can be used for other purposes, specifically in particular for the drive of the chopper drum 26.

In battery operation, the first motor/generator 124 is active as a generator but in harvesting operation provides no power for the electric motors 116, 118 (depending on the throughput and power demand). This is then taken exclusively or partly from the battery. If only relatively little power is needed by the forage harvester, for example in the headland or during a transport journey, a higher voltage than from the power store 140 is provided to the first motor/generator 124 by the control device 94, so that a current flows into the power store and the latter can be recharged. In principle, recharging is carried out when idling, in the headland and during transport.

In addition, even during harvesting operation, under small loads the power store 140 can be charged by the first motor/generator 124 by raising its target voltage. This can primarily be used to displace the load points of the internal combustion engine 36 to a higher efficiency in the fuel consumption characteristic map. Thus the overall efficiency of the forage harvester 10 is raised and less CO₂ is discharged.

By means of the electrical drive of the harvesting attachment by the electric motor 116, the electrical power taken by the latter, which is a measure of the throughput, can be measured permanently. If the stand in parts of the field is particularly dense, an increased power demand can be detected on the harvesting attachment 20. In order to be able to maintain the speed of travel without provoking blockage of the forage harvester 10, a rotational speed predefinition can be sent to the inverter 126 of the first motor/generator 124 with the effect that the internal combustion engine 36 is boosted with energy from the power store 140 by means of additional torque from the first motor/generator 124, and thus does not fail. As already described above, additionally or alternatively the second motor/generator 102 upstream of the clutch 78 can also be used in order to maintain the rotational speed of the chopper drum 26.

It should also be noted that a series of modifications of the embodiments illustrated are conceivable. Thus, the drives of the wheels 14, 16 could also be performed by electric motors, which are each connected to the DC bus 128 by inverters and are controlled by the control device 94, instead of by hydrostatic drives. Here, an electric motor can drive both wheels 14 or 16 of the front and/or rear axle jointly via a gearbox or the wheels are driven individually, in particular by wheel-hub motors. Analogously, the drive of the fan of the main cooling assembly can be electrified. For this purpose, both a single, central electric motor for driving the fan of all the coolers and also a fan array having a plurality of motors and fans are conceivable, which ventilates the individual coolers under application and temperature control.

Furthermore, the drive of the grain processor rollers 38 could be carried out by one or two electric motors, which are connected to the DC bus 128 in a way analogous to the electric motors 112, 116. Here, reference is also made to DE 10 2021 113 626 A1, DE 10 2018 205 221 A1 and DE 10 2013 110 636 A1, the disclosures of which are included by reference in full in the present documents.

Finally, it should also be noted that the operating mode (e) does not depend on the second motor/generator 102 being present, but could also be applied in a forage harvester 10 without this second motor/generator 102. This applies analogously to stopping the feed rollers 22 and the driven elements of the harvesting attachment 20 when the foreign body detector 144 responds in the operating mode (e) described. The details discussed hitherto are also found in DE 10 2023 135 106 A1, the disclosure of which is included by reference in the present documents.

FIG. 3 illustrates how the cooling of the electric motors 112, 116 and the motors/generators 102, 124 is carried out. Hydraulic fluid is taken from a hydraulic oil tank 148 by means of a pump 150, which can be a constituent part of the pumping unit 74, and supplied to a valve block 150. The latter contains an outlet 152 connected directly to its inlet 154 and to which further hydraulically operated elements can be connected, such as actuators for adjusting the discharge elbow 30 or for driving a rotating cleaning screen for cooling air.

The valve block 150 also comprises a number of throttle valves 156 to 170, which on the inlet side are each connected to the inlet 154 and on the outlet side are connected to one of the electric motors 112, 116 or the motors/generators 102, 124. Accordingly, each of the electric motors 112, 116 and motors/generators 102, 124 receives two flows of hydraulic fluid through associated lines 172 and 174. In each case one of these lines 172 leads the hydraulic fluid to the stator and another of the lines 174 leads it to the rotor of the electric motor 112, 116 or motor/generator 102, 124.

The electric motors 112, 116 and motors/generators 102, 124 also each comprise an outlet, which is connected to a return tank 178 via a respective line 176. From there, the hydraulic fluid flows, preferably unpressurized, back into the hydraulic oil tank 148. The latter is additionally connected to an oil cooler 180, which is cooled by an air stream in order to reduce the temperature of the hydraulic fluid.

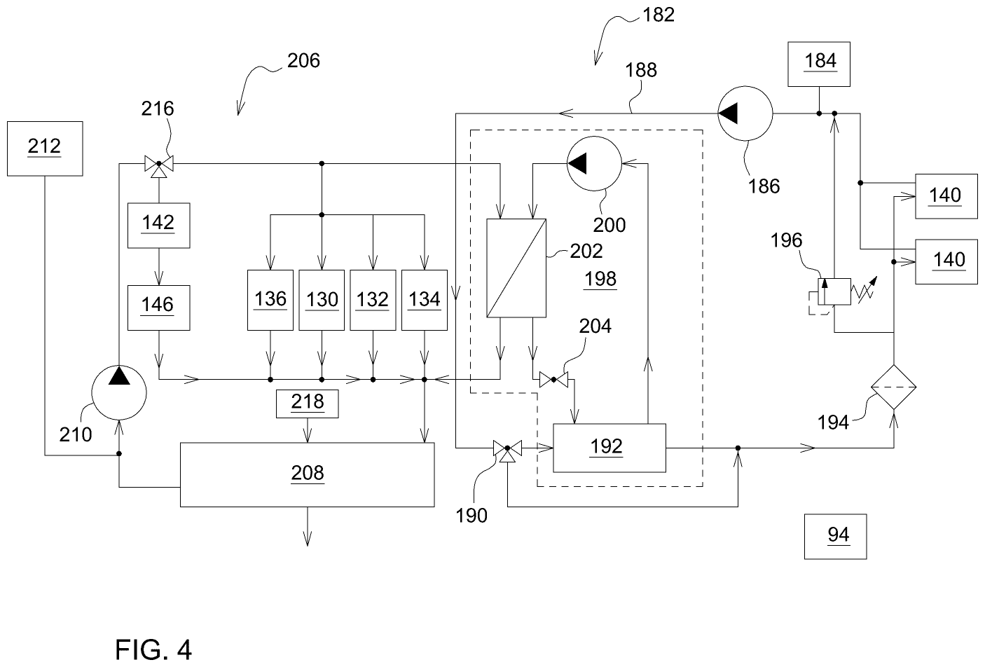

The power store 140 is also equipped with cooling, which is illustrated schematically in FIG. 4. The power store 140 can be subdivided into two or more units which, for example, has the advantage of modular extendibility and exchangeability, as shown in FIG. 4. Because of the high output when charging and discharging the one or more power stores 140, a certain amount of heat loss is produced, which must be dissipated. In addition, at low temperatures, warming up the power stores 140 may also be expedient. The power stores 140 therefore have their temperature controlled via a dielectric (non-conducting) cooling liquid, which flows around the individual cells of the power stores 140, see WO 2017/067923 A1.

This dielectric cooling liquid circulates in a first circuit 182. An expansion tank 184 can accommodate a certain quantity of the dielectric cooling liquid. A first cooling liquid pump 186 conveys the dielectric cooling liquid through a line 188 to an adjustable bypass valve 190, from which part of the dielectric cooling liquid is guided directly and part via a first heat exchanger 192 to a filter 194. On the outlet side, the filter 194 is connected to an inlet of the power stores 140, while the outlet of the power stores is in turn coupled to the expansion tank 184 and the inlet of the first cooling liquid pump 186. In this way, the first cooling liquid pump 186 effects a circulation of the dielectric cooling liquid around the cells of the power stores 140, wherein the proportion of the dielectric cooling liquid which is guided through the first heat exchanger 192 can be varied by the adjustable bypass valve 190.

The aforesaid dissipation of heat from the dielectric cooling liquid is carried out by the first heat exchanger 192, which is cooled by a second circuit 198. In addition to the first heat exchanger 192, this comprises a compressor 200 and a second heat exchanger 202, in particular embodied as a plate heat exchanger, and an expansion valve 204. The second circuit 198 accordingly operates as a heat pump, in that the compressor 200 compresses the refrigerant heated in the first heat exchanger 192 and circulating in the second circuit 198 (e.g. a refrigerant that is usual for heat pumps or air-conditioning systems) and no longer heats the refrigerant, so that the heated refrigerant gives up its heat to a third cooling circuit 206 in the second heat exchanger 202. The pressure of the refrigerant, which is now cooler, is reduced again in the expansion valve 204.

The third cooling circuit 206 comprises a second cooling liquid pump 210, which is connected on the inlet side to the outlet of a cooler 208 through which air flows. The airflow through the cooler 208 is produced by means of a blower 218. The inlet of the second cooling liquid pump 210 is also connected to an expansion tank 212. On the outlet side, the second cooling liquid pump 210 is connected to a bypass valve 216. Its first outlet is connected to the second heat exchanger 202 by lines, and to the inverters 126, 130, 132, 134 (or channels on or in heat sinks of the inverters in order to cool their electronic components, cf. for example WO 2016/094059 A1). On the outlet side, these are connected to the inlet of the cooler 208 by lines. The second outlet of the bypass valve 216 is connected to the charging device 142, connected in series in the embodiment illustrated for the cooling liquid, and to the DC-DC converter 146, the outlet of which is in turn connected to the cooler 208. The third cooling circuit 206 can use water to which antifreeze (e.g. glycol), for example, is added as a cooling liquid. This cooling liquid is supplied by the second cooling liquid pump 210 as required, via the bypass valve 216, to the charging device 142 and the DC-DC converter 146 and also the inverters 126, 130, 132, 134 and the cooler 208.

The electronically adjustable rotational speeds of the cooling liquid pumps 186 and 210 and also of the compressor 200 can be controlled by the control device 94 on the basis of sensors for detecting the temperatures of the cooling liquids and refrigerants in the three cooling circuits 182, 198, 206 (or on the basis of the temperatures of the components to be cooled). In an analogous way, the bypass valves 190 and 216 can also be controlled by the control device 94.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A drive system for a self-propelled agricultural machine, the drive system comprising:
a power store;
a DC bus;
a DC-DC converter connecting the power store and the DC bus;
an inverter;
an electric motor connected to the DC bus via the inverter;
a first cooling circuit operable to circulate a cooling liquid therethrough for dissipating heat from the power store;
a second cooling circuit operable to circulate a refrigerant therethrough for dissipating heat from the cooling liquid of the first cooling circuit; and
a third cooling circuit configured for dissipating heat from the refrigerant of the second cooling circuit, the DC-DC converter, and the inverter.

2. The drive system set forth in claim 1, further comprising an internal combustion engine and a motor/generator that can be brought into drive connection with the internal combustion engine and which is connected by means of a second DC-DC converter to the DC bus, wherein the third coolant circuit is configured for dissipating heat from the second DC-DC converter of the motor/generator.

3. The drive system set forth in claim 1, wherein the second cooling circuit includes a heat pump.

4. The drive system set forth in claim 1, further comprising a cooler operable to dissipate heat from the third cooling circuit into surrounding air.

5. The drive system set forth in claim 4, further comprising a blower operable to generate an air stream that is applied to the cooler.

6. The drive system set forth in claim 1, wherein the first cooling circuit and the second cooling circuit are thermally connected by a first heat exchanger.

7. The drive system set forth in claim 6, wherein the second cooling circuit and the third cooling circuit are thermally connected by a second heat exchanger.

8. The drive system set forth in claim 7, wherein the second cooling circuit includes a compressor disposed between the first heat exchanger and the second heat exchanger, and an expansion valve between the second heat exchanger and the first heat exchanger.

9. The drive system set forth in claim 2, wherein the electric motor and the motor/generator are each cooled by a hydraulic fluid.

10. An agricultural harvesting machine comprising:
a power store;
a DC bus;
a first DC-DC converter connecting the power store and the DC bus;
an inverter;
an electric motor connected to the DC bus via the inverter;
an internal combustion engine;
a motor/generator that can be brought into drive connection with the internal combustion engine and which is connected by means of a second DC-DC converter to the DC bus;
a first cooling circuit operable to circulate a cooling liquid therethrough for dissipating heat from the power store;
a second cooling circuit operable to circulate a refrigerant therethrough for dissipating heat from the cooling liquid of the first cooling circuit;
a third cooling circuit configured for dissipating heat from the refrigerant of the second cooling circuit, the first DC-DC converter, the inverter, and the second DC-DC converter of the motor/generator.

11. The agricultural harvesting machine set forth in claim 10, wherein the second cooling circuit includes a heat pump.

12. The agricultural harvesting machine set forth in claim 10, further comprising a cooler operable to dissipate heat from the third cooling circuit into surrounding air.

13. The agricultural harvesting machine set forth in claim 12, further comprising a blower operable to generate an air stream that is applied to the cooler.

14. The agricultural harvesting machine set forth in claim 10, wherein the first cooling circuit and the second cooling circuit are thermally connected by a first heat exchanger.

15. The agricultural harvesting machine set forth in claim 14, wherein the second cooling circuit and the third cooling circuit are thermally connected by a second heat exchanger.

16. The agricultural harvesting machine set forth in claim 15, wherein the second cooling circuit includes a compressor disposed between the first heat exchanger and the second heat exchanger, and an expansion valve between the second heat exchanger and the first heat exchanger.
